(19) United States
(12) Patent Application Publication
(10) Pub. No.: US 2022/0397323 A1
(43) Pub. Date: Dec. 15, 2022

(54) HEAT PUMP DEVICE, HEAT PUMP SYSTEM, AIR CONDITIONER, AND REFRIGERATION MACHINE

(71) Applicant: Mitsubishi Electric Corporation, Tokyo (JP)

(72) Inventors: Takashi YAMAKAWA, Tokyo (JP); Takamasa ONISHI, Tokyo (JP)

(21) Appl. No.: 17/771,895

(22) PCT Filed: Jan. 21, 2020
(86) PCT No.: PCT/JP2020/001988

§ 371 Date: Apr. 26, 2022

(51) Int. Cl. F25B 49/02; F04B 49/10

(52) U.S. Cl. CPC F25B 49/022; F04B 49/10; F25B 2700/151; F25B 2700/21

(57) ABSTRACT

Included are: a compressor including a compression mechanism that compresses refrigerant, and a motor that drives the compression mechanism; an inverter that applies desired voltage to the motor; an inverter controller that controls the inverter; a high-pressure switch that operates when a discharge pressure of the compressor becomes a preset pressure or higher; and a thermal protector that operates when the temperature of the compressor becomes a preset temperature or higher, wherein the high-pressure switch and the thermal protector are installed on a power supply line for supplying power to the inverter, and the high-pressure switch is opened when the discharge pressure of the compressor becomes the preset pressure or higher, or the thermal protector is opened when the temperature of the compressor becomes the preset temperature or higher, to interrupt power supply to the inverter.

### CROSS REFERENCE TO RELATED APPLICATION

This application is a U.S. National Stage Application of International Patent No. PCT/JP2020/001988 filed on Jan. 21, 2020, the disclosure of which is incorporated herein by reference.

### TECHNICAL FIELD

The present disclosure relates to a heat pump device including a compressor, a heat pump system, an air conditioner, and a refrigeration machine.

### BACKGROUND

In air conditioners including driving circuits for driving compressors, protection of loads such as the compressors against anomalous overheat has been provided. Patent Literature 1 teaches a technology for protecting a load against anomalous overheat in an air conditioner by detecting shell temperature of the load as voltage information, and controlling supply of control voltage to a drive circuit on the basis of a result of comparison between the detected value and a threshold voltage.

### PATENT LITERATURE

Patent Literature 1: International Publication No. WO 2019/123545

According to the aforementioned conventional technology, however, a protection circuit is constituted by a combination of a plurality of circuits such as a thermistor input circuit, a comparator circuit, and a control voltage interrupting circuit. This is problematic in that the number of components increases, the board component area thus increases, and the device is increased in size. In addition, malfunction due to noise is more likely to be caused, and the reliability may be lowered.

### SUMMARY

The present disclosure has been made in view of the above, and an object thereof is to provide a heat pump device capable of performing protecting operation while reducing or preventing an increase in size of the device and reducing or preventing malfunction due to noise.

A heat pump device according to the present disclosure includes: a compressor including a compression mechanism to compress refrigerant, and a motor to drive the compression mechanism; an inverter to apply desired voltage to the motor; an inverter controller to control the inverter; a high-pressure switch to operate when a discharge pressure of the compressor becomes a preset pressure or higher; and a thermal switch to operate when temperature of the compressor becomes a preset temperature or higher, wherein the high-pressure switch and the thermal switch are installed on a power supply line for supplying power to the inverter, and the high-pressure switch is opened when the discharge pressure of the compressor becomes the preset pressure or higher, or the thermal switch is opened when the temperature of the compressor becomes the preset temperature or higher, to interrupt power supply to the inverter.

A heat pump device according to the present disclosure produces an effect of enabling protecting operation while reducing or preventing an increase in size of the device and reducing or preventing malfunction due to noise.

### BRIEF DESCRIPTION OF DRAWINGS

FIG. 1 is a diagram illustrating an example of a configuration of a heat pump device according to a first embodiment.

FIG. 2 is a diagram illustrating a circuit configuration of a control board included in the heat pump device according to the first embodiment.

FIG. 3 is a graph illustrating an example of changes with time of shell temperature, outside air temperature, and a refrigerant stagnation amount of a compressor of the heat pump device according to the first embodiment.

FIG. 4 is a diagram illustrating an example of a hardware configuration for implementing an inverter controller of the control board included in the heat pump device according to the first embodiment.

FIG. 5 is a diagram illustrating a circuit configuration of a control board included in a heat pump device according to a second embodiment.

FIG. 6 is a flowchart illustrating the operation of a system controller included in the heat pump device according to the second embodiment.

FIG. 7 is a diagram illustrating an example of a configuration of a heat pump system including a heat pump device according to a third embodiment.

FIG. 8 is a Mollier diagram of the state of refrigerant in the heat pump device according to the third embodiment.

### DETAILED DESCRIPTION

A heat pump device, a heat pump system, an air conditioner, and a refrigeration machine according to certain embodiments of the present disclosure will be described in detail below with reference to the drawings. Note that the present disclosure is not limited to the embodiments.

### First Embodiment

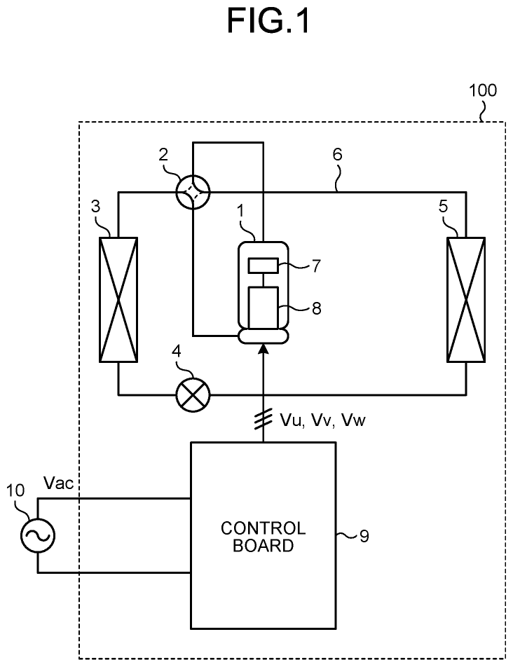

FIG. 1 is a diagram illustrating an example of a configuration of a heat pump device 100 according to a first embodiment. As illustrated in FIG. 1, the heat pump device 100 includes a refrigeration cycle in which a compressor 1, a four-way valve 2, a heat exchanger 3, an expansion mechanism 4, and a heat exchanger 5 are connected in sequence via a refrigerant piping 6. The compressor 1 includes a compression mechanism 7 for compressing refrigerant, and a motor 8 for driving the compression mechanism 7. The motor 8 is a three-phase motor having three-phase wires of U-phase, V-phase, and W-phase.

A control board 9 is electrically connected with the motor 8, and applies voltage to the motor 8 to drive the motor 8. The control board 9 uses alternating-current voltage Vac supplied from an alternating-current power supply 10 as a power supply to generate and apply three-phase voltages Vu, Vv, and Vw to be supplied to the U-phase, V-phase, and W-phase wires of the motor 8.

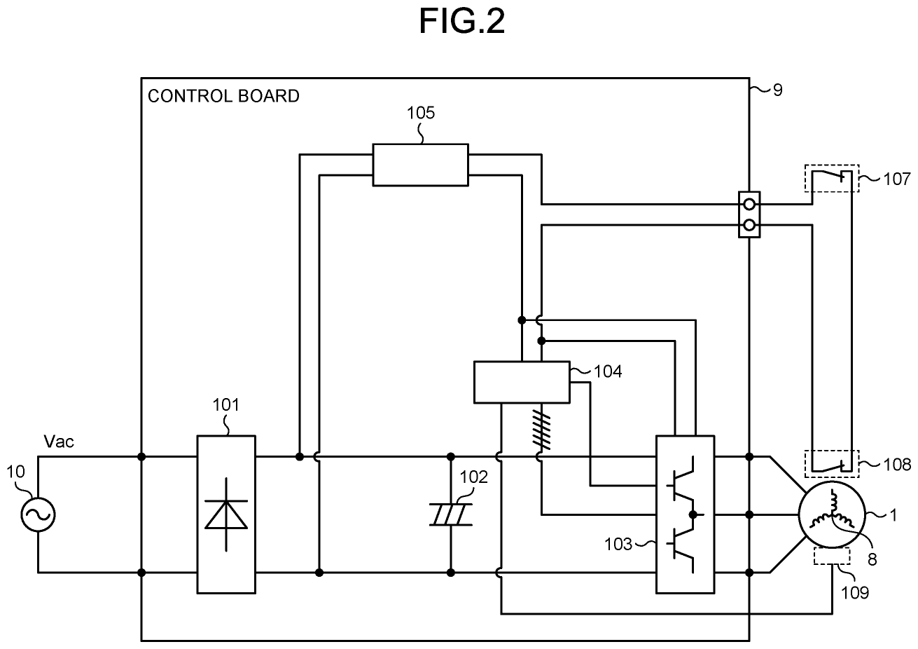

FIG. 2 is a diagram illustrating a circuit configuration of the control board 9 included in the heat pump device 100 according to the first embodiment. The control board 9 includes a rectifier 101, a smoothing capacitor 102, an inverter 103, an inverter controller 104, and a control power supply generating circuit 105. In addition, a high-pressure switch 107, a thermal protector 108, and a compressor thermistor 109 are connected to the control board 9.

The rectifier 101 performs on the alternating-current voltage Vac supplied from the alternating-current power supply 10 to convert the alternating-current voltage Vac into direct-current voltage. The smoothing capacitor 102 smooths the direct-current voltage obtained by the conversion by the rectifier 101 to generate direct-current voltage to be supplied to the inverter 103. The inverter 103 generates the three-phase voltages Vu, Vv, and Vw from the direct-current voltage generated by the smoothing capacitor 102 under the control performed by the inverter controller 104. The inverter 103 applies desired voltage to the motor 8 of the compressor 1.

The control power supply generating circuit 105 generates various control power supplies from the direct-current voltage obtained by the conversion by the rectifier 101. In the present embodiment, the control power supply generating circuit 105 generates control power supplies to be supplied to the inverter 103 and the inverter controller 104.

The inverter controller 104 controls the operation of the entire heat pump device 100. Specifically, the inverter controller 104 controls the circuit direction of the four-way valve 2, the opening degree of the expansion mechanism 4, the speed of a fan, which is not illustrated, for cooling the heat exchanger 5, and the like so that the heat pump device 100 becomes in a desired operation state. The inverter controller 104 also controls the inverter 103 so that the motor 8 of the compressor 1 operates at a desired speed.

The high-pressure switch 107 operates when the discharge pressure of the compressor 1 has become a preset pressure or higher. Specifically, when the pressure in the compressor 1 has become a preset threshold or higher, the high-pressure switch 107 mechanically opens a power supply path from the control power supply generating circuit 105 to mechanically stop compressing operation of the compressor 1. When the pressure in the compressor 1 has become lower than the preset threshold, the high-pressure switch 107 reconnects the power supply path from the control power supply generating circuit 105 to resume the compressing operation of the compressor 1. The high-pressure switch 107 is turned off, that is, opened when the discharge pressure of the compressor 1, that is, the pipe pressure of a refrigerant circuit at an installation position of the high-pressure switch 107 has become 30 Kg/cm² or higher, for example. The high-pressure switch 107 is turned on from off, that is, becomes in a closed state from the open state when the discharge pressure of the compressor 1, that is, the pipe pressure of the refrigerant circuit at the installation position of the high-pressure switch 107 as become lower than 28.5 Kg/cm², for example. Thus, the high-pressure switch 107 does not return until the discharge pressure of the compressor 1, that is, the pipe pressure of the refrigerant circuit at the installation position of the high-pressure switch 107 becomes lower than 28.5 Kg/cm². It takes several seconds for the high-pressure switch 107 according to the present embodiment to return. Alternatively, the high-pressure switch 107 may be installed on a power supply line for the inverter controller 104 and the inverter 103 via a relay or the like.

The thermal protector 108 operates when the shell temperature of the compressor 1 has become a preset temperature or higher. Specifically, the thermal protector 108 is mounted on a shell of the compressor 1. When the shell temperature of the compressor 1 has become a preset threshold or higher, the thermal protector 108 mechanically opens the power supply path from the control power supply generating circuit 105 to mechanically stop the compressing operation of the compressor 1. When the shell temperature of the compressor 1 has become lower than the preset threshold, the thermal protector 108 reconnects the power supply path from the control power supply generating circuit 105 to resume the compressing operation of the compressor 1. The thermal protector 108 is turned off, that is, opened when the shell temperature of the compressor 1 has become 125° C. or higher, for example. The thermal protector 108 is turned on from off, that is, becomes in a closed state from the open state when the shell temperature of the compressor 1 has become lower than 90° C., for example. Thus, the thermal protector 108 does not return until the shell temperature of the compressor 1 becomes lower than 90° C. It takes several tens of minutes for the thermal protector 108 according to the present embodiment to return. The time taken until return depends on the threshold of the thermal protector 108, the heat capacity of the compressor 1, outside air temperature, and the like. Alternatively, the thermal protector 108 may be installed on the power supply line for the inverter controller 104 and the inverter 103 via a relay or the like. Preferably, the shell temperature of the compressor 1 does not exceed 150° C. Thus, although it depends on the temperature difference between the shell of the compressor 1 and the thermal protector 108, it is suitable that the temperature at which the thermal protector 108 is opened is set to 115 to 135° C. In the description below, the thermal protector 108 may be referred to as a thermal switch. In addition, in the description below, the shell temperature of the compressor 1 may simply be referred to as the temperature of the compressor 1. Note that the thermal protector 108 may be mounted on any position of the shell of the compressor 1. The position at which thermal protector 108 is mounted may be selected in view of the structure of the compressor 1 and the situation in which the compressor 1 is to be protected. For example, in a case where protection when the motor 8 of the compressor 1 is locked is also assumed, for example, the thermal protector 108 is preferably mounted at a position of the shell of the compressor 1 near the motor 8 of the compressor 1.

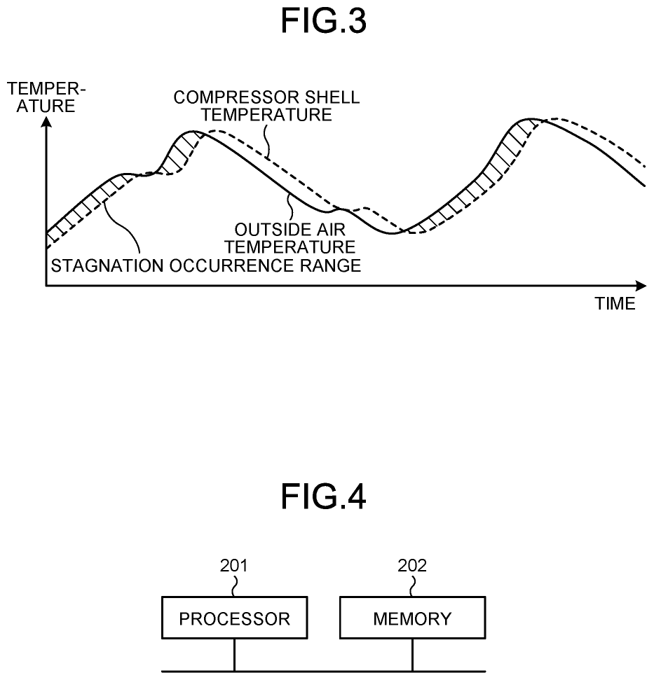

The compressor thermistor 109 is a compressor temperature detector that is mounted on the shell of the compressor 1, and detects the shell temperature of the compressor 1. In addition, the compressor thermistor 109 is connected with the inverter controller 104. The inverter controller 104 limits the operation of the compressor 1 to reduce or prevent an increase in the shell temperature of the compressor 1 on the basis of a detected value from the compressor thermistor 109. In addition, the inverter controller 104 also detects the outside air temperature, so that the amount of liquid refrigerant stagnating in the compressor 1 can be estimated on the basis of the temperature difference from the shell temperature of the compressor 1. Note that, because the compressor 1 has a largest heat capacity in the refrigeration cycle and the temperature thereof rises with a lag after a rise in the outside air temperature, the compressor 1 has a lowest temperature in the refrigeration cycle. Thus, the temperature relation is as illustrated in FIG. 3. FIG. 3 is a graph illustrating an example of changes with time of the shell temperature, the outside air temperature, and the refrigerant stagnation amount of the compressor 1 of the heat pump device 100 according to the first embodiment. In FIG. 3, the horizontal axis represents time, and the vertical axis represents temperature. The inverter controller 104 can determine whether or not stagnation of refrigerant in the compressor 1 is present on the basis of the detected value from the compressor thermistor 109, that is, the relation between the shell temperature of the compressor 1 and the outside air temperature, and control overheated operation of the compressor 1.

The high-pressure switch 107 and the thermal protector 108 are located on the power supply line for supplying power from the control power supply generating circuit 105 to the inverter 103 and the inverter controller 104. As described above, although determination is made on different parameters from each other, which are the pressure and the temperature, the high-pressure switch 107 and the thermal protector 108 can perform similar protecting operation to interrupt power supply to the inverter controller 104 and the inverter 103 to stop the compressor 1. Thus, in the present embodiment, the high-pressure switch 107 and the thermal protector 108 are connected in series via the line, and thus uses a common line. As a result, the heat pump device 100 can use a common specification for the control board 9, and can use a combination of the common specification for the control board 9 and at least one of the specification of the high-pressure switch 107 and the specification of the thermal protector 108 selected depending on the application. The heat pump device 100 can have a configuration excluding the high-pressure switch 107 depending on the application thereof.

In addition, the heat pump device 100 can reduce or prevent an increase in the board component area resulting from addition of connectors to the control board 9. Furthermore, as compared with a case where the high-pressure switch 107 and the thermal protector 108 are located on different lines, the heat pump device 100 can shorten the total line length, and can reduce the cost and reduce or prevent malfunction due to the influence of noise.

In the heat pump device 100 having the configuration as described above, when the discharge pressure of the compressor 1 has become a preset pressure, such as 30 Kg/cm², or higher, the high-pressure switch 107 operates and power supply to the inverter controller 104 and the inverter 103 is interrupted. This enables the heat pump device 100 to reliably stop the compressor 1 even in such a case where the inverter controller 104 cannot operate normally owing to runaway or the like.

In the heat pump device 100 having the configuration as described above, when the shell temperature of the compressor 1 has become a preset temperature, such as 125° C., or higher, the thermal protector 108 operates and power supply to the inverter controller 104 and the inverter 103 is interrupted. This enables the heat pump device 100 to reliably stop the compressor 1 even in such a case where the inverter controller 104 cannot operate normally owing to runaway or the like.

While the heat pump device 100 interrupts power supply to the inverter controller 104 and the inverter 103 to stop the compressor 1 in the present embodiment, the interruption is not limited thereto. The heat pump device 100 may interrupt power supply to either one of the inverter controller 104 and the inverter 103 to stop the compressor 1. Specifically, the high-pressure switch 107 and the thermal protector 108 interrupt at least one of a connection point between the control power supply generating circuit 105 that supplies control power to the inverter 103 and the inverter 103 and a connection point between the control power supply generating circuit 105 that supplies control power to the inverter controller 104 and the inverter controller 104. In the present embodiment, in order to more reliably stop the compressor 1, the heat pump device 100 interrupts power supply to the inverter controller 104 and the inverter 103 to stop the compressor 1.

In addition, while the inverter controller 104 controls only the inverter 103 in the present embodiment, the inverter controller 104 may control an inverter for driving a fan motor, an active converter, and the like. In this case, the heat pump device 100 can stop the inverter 103, the inverter for driving the fan motor, the active converter, and the like, which are controlled by the inverter controller 104, by interrupting power supply to the inverter controller 104. This configuration enables a system with higher reliability and quality to be built.

Next, a hardware configuration of the inverter controller 104 of the control board 9 included in the heat pump device 100 will be described. FIG. 4 is a diagram illustrating an example of the hardware configuration for implementing the inverter controller 104 of the control board 9 included in the heat pump device 100 according to the first embodiment. The inverter controller 104 of the control board 9 is implemented by a processor 201 and a memory 202.

The processor 201 is a central processing unit (CPU; also referred to as a central processing device, a processing device, a computing device, a microprocessor, a microcomputer, a processor, or a digital signal processor (DSP)), or a system large scale integration (LSI). Examples of the memory 202 can include nonvolatile or volatile semiconductor memories such as a random access memory (RAM), a read only memory (ROM), a flash memory, an erasable programmable read only memory (EPROM), and an electrically erasable programmable read only memory (EEPROM: registered trademark). Alternatively, the memory 202 is not limited thereto, and may be a magnetic disk, an optical disk, a compact disk, a mini disc, or a digital versatile disc (DVD).

### Second Embodiment

In a second embodiment, a case where part of control performed by the inverter controller 104 in the first embodiment is performed by another controller will be described.

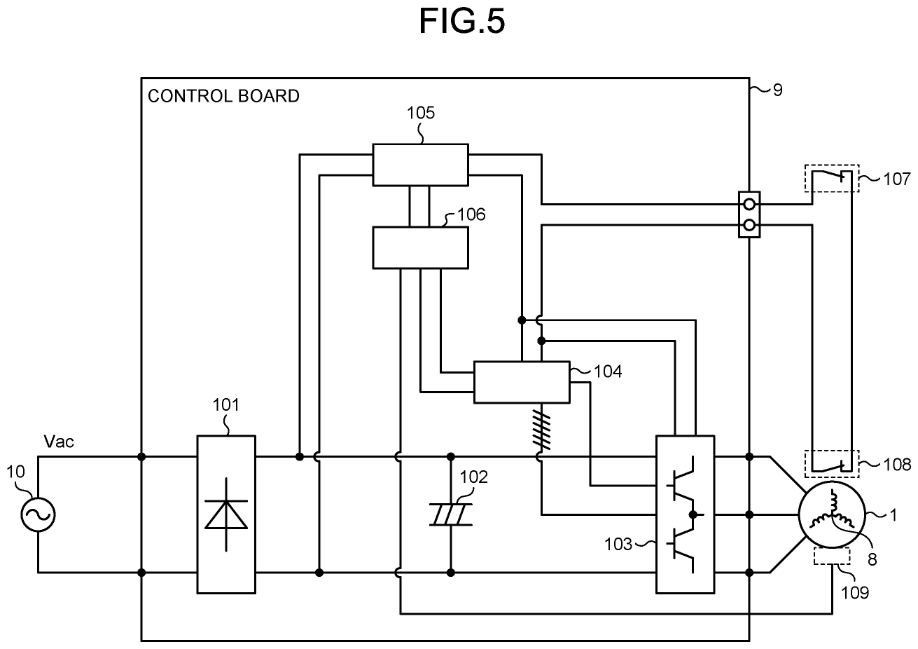

FIG. 5 is a diagram illustrating a circuit configuration of the control board 9 included in the heat pump device 100 according to the second embodiment. The control board 9 additionally includes a system controller 106 as compared with the control board 9 in the first embodiment illustrated in FIG. 2. In the present embodiment, the heat pump device 100 has a configuration including the inverter controller 104 and the system controller 106, that is, two controllers, so that control of some targets controlled by the inverter controller 104 are transferred to the system controller 106.

The system controller 106 is a host controller that controls the operation of the entire heat pump device 100. Specifically, the system controller 106 controls the circuit direction of the four-way valve 2, the opening degree of the expansion mechanism 4, the speed of a fan, which is not illustrated, for cooling the heat exchanger 5, and the like so that the heat pump device 100 becomes in a desired operation state. The system controller 106 also outputs operation commands to the inverter controller 104 so that the motor 8 of the compressor 1 operates at a desired speed. The inverter controller 104 controls the motor 8 in accordance with the operation commands from the system controller 106.

In the second embodiment, the control power supply generating circuit 105 also generates a control power supply to be supplied to the system controller 106, and supplies control power to the inverter 103 and the inverter controller 104 through different paths from each other.

Thus, the heat pump device 100 can supply power to the system controller 106 even in a state in which power supply to the inverter controller 104 and the inverter 103 is interrupted. In addition, the system controller 106 can recognize that either of the high-pressure switch 107 and the thermal protector 108 has operated.

In the heat pump device 100, the time from interruption of power supply to the inverter controller 104 and the inverter 103 until the power supply is restored is normally several tens of minutes in the case of thermal protector 108, relative to several seconds in the case of high-pressure switch 107, for example, which is a large difference. Thus, the system controller 106 can determine which has operated by measuring the time from interruption of power supply to the inverter controller 104 and the inverter 103 until the power supply is restored. The time from interruption of power supply until the power supply is restored is referred to as power supply interruption time. Alternatively, the system controller 106 may determine that the thermal protector 108 has operated when a predetermined time has passed after interruption, instead of making a decision after the restore of the power supply.

The method for detecting interruption of power supply may be such that the system controller 106 may directly detect voltage, or may detect a signal indicating interruption of power supply via a photo-coupler, a transistor, or the like.

Alternatively, the system controller 106 may perform determination on the basis of the shell temperature, pressure information, or the like of the compressor 1 at the timing of occurrence of interruption or at the timing of restoration, in addition to the time, and the determination based on the combination enables more accurate determination on which of the high-pressure switch 107 and the thermal protector 108 has operated. Specifically, the system controller 106 determines which of the high-pressure switch 107 and the thermal protector 108 has operated by using at least one of the detected value from the compressor thermistor 109 and the power supply interruption time.

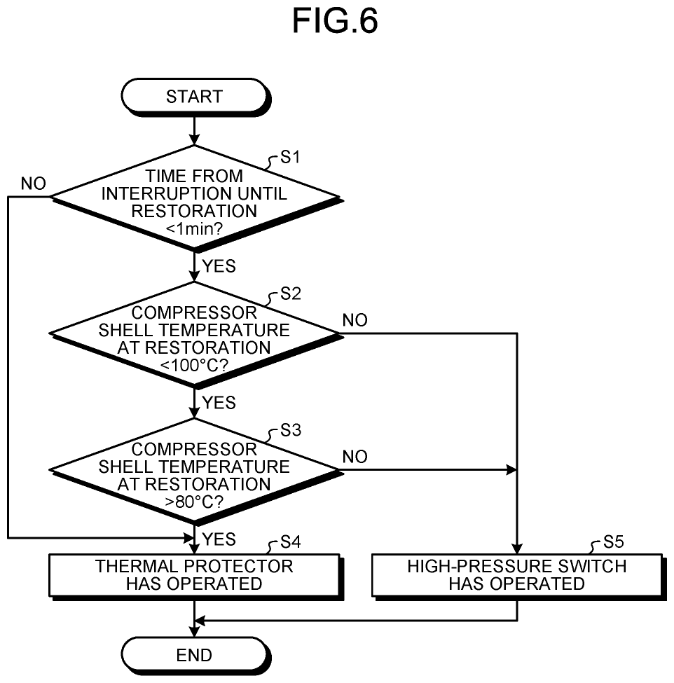

FIG. 6 is a flowchart illustrating the operation of the system controller 106 included in the heat pump device 100 according to the second embodiment. The system controller 106 determines whether or not the time from interruption of control power supply until restoration thereof is smaller than one minute (step S1). As described above, this is based on the characteristics that it normally takes about several tens of minutes to restore in the case of the operation of the high-pressure switch 107 while it normally takes several seconds to restore in the case of the operation of the thermal protector 108. If the time from interruption of control power supply until restoration thereof is smaller than one minute (step S1: Yes), the system controller 106 determines whether or not the shell temperature of the compressor 1 when the control power supply is restored is lower than 100° C. (step S2). If the shell temperature of the compressor 1 when the control power supply is restored is lower than 100° C. (step S2: Yes), the system controller 106 determines whether or not the shell temperature of the compressor 1 when the control power supply is restored is higher than 80° C. (step S3).

In step S2 and step S3, in a case where the return temperature for the thermal protector 108 is set to 90° C., when the temperature differs by ±10° C. or larger, the system controller 106 determines that it is not the thermal protector 108 but the high-pressure switch 107 that has operated. Note that the return temperature needs to be set in view of differences in detected temperatures caused by the positions at which the thermal protector 108 and the compressor thermistor 109 are mounted, the characteristics thereof, and the like. If the shell temperature of the compressor 1 when the control power supply is restored is higher than 80° C. (step S3: Yes), the system controller 106 determines that the thermal protector 108 has operated (step S4). If the time from interruption of control power supply until restoration thereof is equal to or longer than one minute (step S1: No), the system controller 106 determines that the thermal protector 108 has operated (step S4). If the shell temperature of the compressor 1 at the restoration of the control power supply is equal to or higher than 100° C. (step S2: No) or if the shell temperature of the compressor 1 at the restoration of the control power supply is equal to or lower than 80° C. (step S3: No), the system controller 106 determines that the high-pressure switch 107 has operated (step S5).

The system controller 106 can perform a three-minute restart prevention mode through the operations as described above. As a result, even when the high-pressure switch 107 has operated, the heat pump device 100 can prevent activation in a state in which the pressure difference is large, and reduce or prevent breakage caused by pipe vibration or the like, thereby enabling a system with high reliability to be built.

In the present embodiment, the heat pump device 100 includes two separate controllers, which are the system controller 106 and the inverter controller 104. Thus, the heat pump device 100 can be implemented by a microcomputer that is low in cost with low arithmetic processing capacity and a small number of pins even in a complicated system.

While the heat pump device 100 includes two separate controllers, which are the system controller 106 and the inverter controller 104, in the present embodiment, this is an example, and three or more controllers may be included. In this case, the heat pump device 100 can build a more reliable system by building a system in which the controllers are mutually monitored.

In addition, because the heat pump device 100 can determine which of the high-pressure switch 107 and the thermal protector 108 has operated, a system with high service performance and maintenance performance can be achieved.

Furthermore, in the heat pump device 100, temperature detecting means is not limited to the compressor thermistor 109, and the shell temperature of the compressor 1 may be estimated on the basis of output information of the inverter 103, ambient temperature of the compressor 1, outside air temperature, and the like.

In addition, the inverter controller 104 and the system controller 106 may be mounted on different control boards. In this case, when the system controller 106 and the control power supply generating circuit 105 are installed on one control board, it becomes easy to form paths for interrupting power supply to the inverter controller 104 and the inverter 103.

Although the control power supply for the inverter controller 104 and the inverter 103 is one control power supply from the control power supply generating circuit 105, a voltage of control power supply in a case where the inverter 103 is an intelligent power module (IPM) is 15 V, while a voltage of control power supply in a case where the inverter controller 104 is a microcomputer is often 3.3 V or 5 V, for example. Thus, the heat pump device 100 may supply control power supplies to the inverter controller 104 and the inverter 103 from control power supply generating circuits different to each other. The control power supply generating circuit 105 may generate control power supplies for the inverter controller 104 and the inverter 103 from one power supply, or a step-down circuit, which is not illustrated, may lower the voltage of control power supply of the inverter 103 and supply the resulting control power supply to the inverter controller 104. The step-down circuit, which is not illustrated, lowers the voltage of control power supply of 15 V for the inverter 103 to generate control power supply of 3.3 V or 5 V. In this case, it is relatively easy to simultaneously interrupt the control power supplies to the inverter controller 104 and the inverter 103.

Note that the hardware configuration of the system controller 106 of the control board 9 included in the heat pump device 100 is also constituted by the processor 201 and the memory 202 in a manner similar to the inverter controller 104.

### Third Embodiment

In a third embodiment, a heat pump system including the heat pump device 100 will be described. Examples of the heat pump system include a conditioner, a heat pump water heater, a refrigerator, and a refrigeration machine, but the heat pump system is not limited thereto.

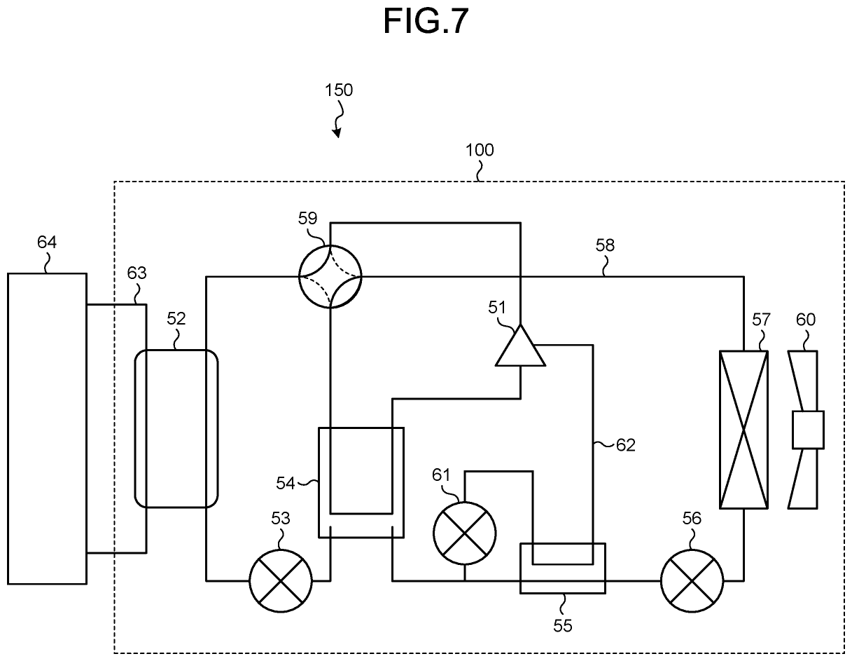

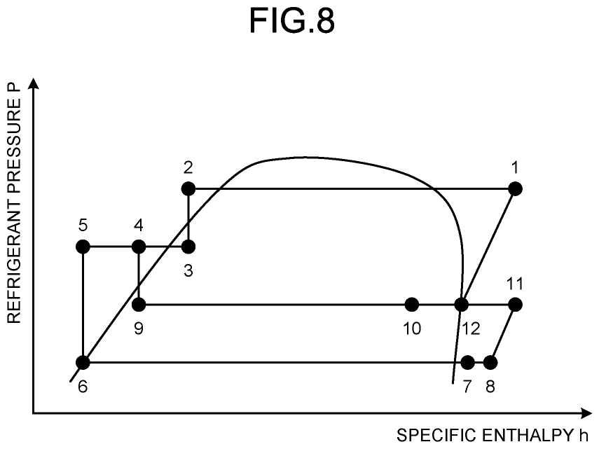

FIG. 7 is a diagram illustrating an example of a configuration of a heat pump system 150 including the heat pump device 100 according to the third embodiment. FIG. 8 is a Mollier diagram of the state of refrigerant in the heat pump device 100 according to the third embodiment. In FIG. 8, the horizontal axis represents specific enthalpy, and the vertical axis represents refrigerant pressure.

The heat pump device 100 of the present embodiment includes a main refrigerant circuit 58 in which a compressor 51, a heat exchanger 52, an expansion mechanism 53, a receiver 54, an internal heat exchanger 55, an expansion mechanism 56, and a heat exchanger 57 are sequentially connected via pipes, and through which refrigerant circulates. The main refrigerant circuit 58 includes a four-way valve 59 on a discharge side of the compressor 51, which enables switching of the circulating direction of the refrigerant. In addition, the main refrigerant circuit 58 includes a fan 60 near the heat exchanger 57. Note that the compressor 51 illustrated in FIG. 7 corresponds to the compressor 1 described in the first and second embodiments including the motor 8 driven by the inverter 103 and the compression mechanism 7. For simplicity of description, the control board 9 and the like are not illustrated in the heat pump system 150 illustrated in FIG. 7. In the description below, the heat exchanger 52 may be referred to as a first heat exchanger, and the heat exchanger 57 may be referred to as a second heat exchanger.

Furthermore, the heat pump device 100 also includes an injection circuit 62 that connects from between the receiver 54 and the internal heat exchanger 55 to an injection pipe of the compressor 51 via pipes. The expansion mechanism 61 and the internal heat exchanger 55 are sequentially connected with the injection circuit 62. A water circuit 63 through which water circulates is connected with the heat exchanger 52. A fluid using device 64 that uses water, such as a water heater, a radiator, a radiator for floor heating, or the like, is connected with the water circuit 63. The fluid using device 64 included in the heat pump system 150 is a device that uses fluid resulting from heat exchange performed by the heat exchanger 52.

First, the operation of the heat pump device 100 of the present embodiment during heating operation will be described. During heating operation, the four-way valve 59 is set in the direction of the solid lines. Note that the heating operation includes not only heating used by an air conditioner but also hot water supply that heats water to make hot water.

Gas-phase refrigerant (point 1 in FIG. 8) that has high temperature and pressure in the compressor 51 is discharged from the compressor 51, subjected to heat exchange by the heat exchanger 52 that is a condenser and serving as a radiator, and thus liquefied (point 2 in FIG. 8). In this process, the water circulating through the water circuit 63 is heated by heat radiated from the refrigerant, and used for heating, hot water supply, and the like.

The liquid-phase refrigerant resulting from the liquefaction in the heat exchanger 52 is reduced in pressure by the expansion mechanism 53, and thus changed into a gas-liquid two-phase state (point 3 in FIG. 8). The refrigerant changed into the gas-liquid two-phase state by the expansion mechanism 53 is subjected to heat exchange at the receiver 54 with refrigerant sucked into the compressor 51, and thus cooled and liquefied (point 4 in FIG. 8). The liquid-phase refrigerant resulting from the liquefaction in the receiver 54 is divided into a flow through the main refrigerant circuit 58 and a flow through the injection circuit 62.

The liquid-phase refrigerant flowing through the main refrigerant circuit 58 is reduced in pressure by the expansion mechanism 61, and subjected to heat exchange at the internal heat exchanger 55 with the refrigerant changed into the gas-liquid two-phase state and flowing through the injection circuit 62, and thus cooled (point 5 in FIG. 8). The liquid-phase refrigerant resulting from the cooling in the internal heat exchanger 55 is reduced in pressure by the expansion mechanism 56, and thus changed into a gas-liquid two-phase state (point 6 in FIG. 8). The refrigerant changed into the gas-liquid two-phase state by the expansion mechanism 56 is subjected to heat exchange with outside air at the heat exchanger 57 that serves as an evaporator, and thus heated (point 7 in FIG. 8). The refrigerant heated by the heat exchanger 57 is then further heated at the receiver 54 (point 8 in FIG. 8), and sucked into the compressor 51.

Meanwhile, the refrigerant flowing through the injection circuit 62 is reduced in pressure by the expansion mechanism 61 (point 9 in FIG. 8), and subjected to heat exchange at the internal heat exchanger 55 (point 10 in FIG. 8) as described above. The refrigerant in the gas-liquid two-phase state resulting from the heat exchange at the internal heat exchanger 55, that is, injection refrigerant flows into the compressor 51 through the injection pipe of the compressor 51 while maintaining the gas-liquid two-phase state.

In the compressor 51, the refrigerant sucked from the main refrigerant circuit 58 (point 8 in FIG. 8) is compressed to have an intermediate pressure and heated (point 11 in FIG. 8). The refrigerant compressed to have the intermediate pressure and heated (point 11 in FIG. 8) is merged with the injection refrigerant (point 10 in FIG. 8), and is thus decreased in temperature (point 12 in FIG. 8). The refrigerant decreased in temperature (point 12 in FIG. 8) is then further compressed and heated to have high temperature and high pressure, and discharged (point 1 in FIG. 8).

Note that, when the heat pump device 100 does not perform the injection operation, the opening degree of the expansion mechanism 61 is set to fully closed. In other words, while the opening degree of the expansion mechanism 61 is larger than a predetermined opening degree when the heat pump device 100 performs the injection operation, the opening degree of the expansion mechanism 61 is set to be smaller than the predetermined opening degree when the heat pump device 100 does not perform the injection operation. The refrigerant thus does not flow into the injection pipe of the compressor 51.

Note that the opening degree of the expansion mechanism 61 is electronically controlled by a controller such as a microcomputer.

Next, the operation of the heat pump device 100 of the present embodiment during cooling operation will be described. During cooling operation, the four-way valve 59 is set in the direction of the broken lines. Note that the cooling operation includes not only cooling used by an air conditioner but also conducting heat away from water to make cold water, refrigeration, and the like.

Gas-phase refrigerant (point 1 in FIG. 8) that comes to have high temperature and pressure in the compressor 51 is discharged from the compressor 51, subjected to heat exchange by the heat exchanger 57 that is a condenser and serving as a radiator, and thus liquefied (point 2 in FIG. 8). The liquid-phase refrigerant resulting from the liquefaction in the heat exchanger 57 is reduced in pressure by the expansion mechanism 56, and thus changed into a gas-liquid two-phase state (point 3 in FIG. 8). The refrigerant changed into the gas-liquid two-phase state by the expansion mechanism 56 is subjected to heat exchange in the internal heat exchanger 55, and thus cooled and liquefied (point 4 in FIG. 8). In the internal heat exchanger 55, heat exchange is carried out between the refrigerant changed into the gas-liquid two-phase state by the expansion mechanism 56, and the refrigerant changed into the gas-liquid two-phase state (point 9 in FIG. 8) that is obtained such that the liquid-phase refrigerant resulting from the liquefaction in the internal heat exchanger 55 is reduced in pressure by the expansion mechanism 61. The liquid-phase refrigerant (point 4 in FIG. 8), which results from the heat exchange in the internal heat exchanger 55, is divided into a flow through the main refrigerant circuit 58 and a flow through the injection circuit 62.

The liquid-phase refrigerant flowing through the main refrigerant circuit 58 is subjected to heat exchange at the receiver 54 with the refrigerant sucked into the compressor 51, and thus further cooled (point 5 in FIG. 8). The liquid-phase refrigerant resulting from the cooling in the receiver 54 is reduced in pressure by the expansion mechanism 53, and thus changed into the gas-liquid two-phase state (point 6 in FIG. 8). The refrigerant changed into the gas-liquid two-phase state by the expansion mechanism 53 is subjected to heat exchange at the heat exchanger 52 that serves as an evaporator, and is thus heated (point 7 in FIG. 8). In this process, the refrigerant absorbs heat to cool the water circulating through the water circuit 63, which is used for cooling, refrigeration, and the like. As described above, the heat pump device 100 according to the present embodiment constitutes the heat pump system 150 together with the fluid using device 64 that uses water, that is, fluid circulating through the water circuit 63. The heat pump system 150 can be used in an air conditioner, a heat pump water heater, a refrigerator, a refrigeration machine, and the like.

The refrigerant heated by the heat exchanger 52 is then further heated at the receiver 54 (point 8 in FIG. 8), and sucked into the compressor 51.

Meanwhile, the refrigerant flowing through the injection circuit 62 is reduced in pressure by the expansion mechanism 61 (point 9 in FIG. 8), and subjected to heat exchange at the internal heat exchanger 55 (point 10 in FIG. 8) as described above. The refrigerant (injection refrigerant) in the gas-liquid two-phase state resulting from the heat exchange in the internal heat exchanger 55 flows into the compressor 51 through the injection pipe while maintaining the gas-liquid two-phase state. The compressing operation in the compressor 51 is similar to that during heating operation.

Note that, when the heat pump device 100 does not perform the injection operation, the opening degree of the expansion mechanism 61 is set to fully closed, so that the refrigerant does not flow into the injection pipe of the compressor 51, in a manner similar to the heating operation.

In addition, in the description above, the heat exchanger 52 is explained as being such a heat exchanger as a plate type heat exchanger that provides heat exchange between the refrigerant and the water circulating through the water circuit 63. The heat exchanger 52 is not limited thereto, and may provide heat exchange between the refrigerant and air. In addition, regarding the water circuit 63, a circuit through which another fluid circulates can be used instead of the circuit through which water circulates.

As described above, the heat pump device 100 can be used for heat pump devices including an inverter compressor, such as an air conditioner, a heat pump water heater, a refrigerator, and a refrigeration machine.

The configurations presented in the embodiments above are examples, and can be combined with other known technologies or with each other, or can be partly omitted or modified without departing from the gist.

1. A heat pump device comprising:
a compressor including a compression mechanism to compress refrigerant, and a motor to drive the compression mechanism;
an inverter to apply desired voltage to the motor;
an inverter controller comprising a first processor and a first memory to store a first program which, when executed by the first processor, performs processes to control the inverter;
a control power supply generating circuit to supply control power to the inverter and the inverter controller;
a high-pressure switch to operate when a discharge pressure of the compressor becomes a preset pressure or higher; and
a thermal switch to operate when temperature of the compressor becomes a preset temperature or higher, wherein
the high-pressure switch and the thermal switch are installed on a power supply line for supplying power to the inverter, connected in series via a line and connected, via one connector, to a control board on which at least one of the inverter controller and the control power supply generating circuit is mounted, and
the high-pressure switch is opened when the discharge pressure of the compressor becomes the preset pressure or higher, or the thermal switch is opened when the temperature of the compressor becomes the preset temperature or higher, to interrupt power supply to the inverter.

2. (canceled)

3. The heat pump device according to claim 1 or 2, wherein the high-pressure switch and the thermal switch interrupt at least one of a connection point between the control power supply generating circuit to supply control power to the inverter and the inverter and a connection point between the control power supply generating circuit to supply control power to the inverter controller and the inverter controller.

4. The heat pump device according to claim 1, comprising a host controller comprising a second processor and a second memory to store a second program which, when executed by the second processor, performs processes to output an operation command to the inverter controller.

5. The heat pump device according to claim 4, wherein the first processor of the inverter controller controls the motor on the basis of the operation command from the host controller.

6. The heat pump device according to claim 4 or 5, wherein the second processor of the host controller determines by which of the high-pressure switch and the thermal switch, power supply to the inverter is interrupted.

7. The heat pump device according to claim 6, wherein the second processor of the host controller measures a power supply interruption time from interruption of power supply to the inverter until the power supply is restored.

8. The heat pump device according to claim 7, comprising a compressor temperature detector to detect the temperature of the compressor, wherein the second processor of the host controller determines which of the high-pressure switch and the thermal switch operates by using at least one of: a detected value from the compressor temperature detector and the power supply interruption time.

9. The heat pump device according to claim 1, comprising a compressor temperature detector to detect the temperature of the compressor.

10. A heat pump system comprising:
the heat pump device according to claim 1 including a refrigerant circuit in which a compressor, a first heat exchanger, an expansion mechanism, and a second heat exchanger are connected via pipes; and
a fluid using device to use fluid resulting from heat exchange performed by the first heat exchanger.

11. An air conditioner comprising the heat pump device according to claim 1.

12. A refrigeration machine comprising the heat pump device according to claim 1.
